(19) United States
(12) Patent Application Publication
(10) Pub. No.: US 2016/0083566 A1
(43) Pub. Date: Mar. 24, 2016

(54) RUBBER COMPOSITION AND SLIDE MEMBER

(71) Applicant: Hitachi Metals, Ltd., Tokyo (JP)

(72) Inventors: Kei TAKAHASHI, Sendai (JP); Mika HAYASHI, Sendai (JP); Kazuo HOKKIRIGAWA, Sendai (JP); Takeshi YAMAGUCHI, Sendai (JP); Kei SHIBATA, Sendai (JP)

(21) Appl. No.: 14/851,520

(22) Filed: Sep. 11, 2015

(30) Foreign Application Priority Data
Sep. 18, 2014 (JP) 2014-190440

(51) Int. Cl. C08K 7/24

(52) U.S. Cl. CPC C08K 7/24

(57) ABSTRACT

A rubber composition includes an ethylene-propylene-diene rubber, and a porous carbon particle derived from a plant material. Not less than 160 parts by mass and not more than 340 parts by mass of the porous carbon particle is included relative to 100 parts by mass of the ethylene-propylene-diene rubber. A slide member includes a cross-linked rubber body in which the rubber composition is cross-linked.

The present application is based on Japanese patent application No. 2014-190440 filed on Sep. 18, 2014, the entire contents of which are incorporated herein by reference.

### BACKGROUND OF THE INVENTION

1. Field of the Invention

The invention relates to a rubber composition and a slide member formed of the rubber composition.

2. Description of the Related Art

Slide members are used as, e.g. gears in industrial equipment and bearings or shaft seals etc. for metal shafts. In general, the slide members need to be excellent in sliding properties to have a low coefficient of friction as well as to be excellent in wear resistance to have a low wear rate. To form a slide member to satisfy such properties, e.g., a resin material formed of a synthetic resin containing RB ceramics particles is used (see e.g. JP-B-4031266). Also, carbon materials etc. are used. The RB ceramics particles are a type of porous carbon particles (hereinafter, also simply referred to as “porous carbon particles”) derived from plant materials.

### SUMMARY OF THE INVENTION

The resin material disclosed in JP-B-4031266 or carbon materials lack rubber elasticity, so that a slide member formed of such materials may be broken by impact.

Thus, a material to form the slide member is desired to be a rubber composition which has rubber elasticity, a coefficient of friction as low as that of resin materials etc. and excellent wear resistance.

It is an object of the invention to provide a rubber composition that is low in coefficient of friction and excellent in wear resistance, as well as a slide member using the rubber composition.
(1) According to one embodiment of the invention, a rubber composition comprises:
   an ethylene-propylene-diene rubber; and
   a porous carbon particle derived from a plant material,
   wherein not less than 160 parts by mass and not more than 340 parts by mass of the porous carbon particle is comprised relative to 100 parts by mass of the ethylene-propylene-diene rubber.
(2) According to another embodiment of the invention, a slide member comprises a cross-linked rubber body in which the rubber composition according to the above embodiment (1) is cross-linked.

### Effects of the Invention

According to one embodiment of the invention, a rubber composition can be provided that is low in coefficient of friction and excellent in wear resistance, as well as a slide member using the rubber composition.

### DETAILED DESCRIPTION OF THE PREFERRED EMBODIMENT

In order to solve the problems mentioned above, the present inventors examined rubber compositions formed of various rubbers with various porous carbon particle contents. As a result, it was found that a rubber to be used is preferably ethylene-propylene-diene rubber (hereinafter, also simply referred to as “EPDM rubber”), and also the porous carbon particle content is preferably high. Then, it was found that, when cross-linking a rubber composition obtained by adding a large amount of porous carbon particles to EPDM rubber, a low specific wear rate and high wear resistance are obtained, and in addition to this, a coefficient of friction is smaller than that of rubber compositions using other rubbers and sliding properties are further improved. In detail, it was found that a slide member formed using such a rubber composition can have a lower coefficient of friction in the air and also a lower coefficient of friction in water when sliding against another member at a low speed and with a small load. The invention was made based on such findings.

### Embodiment of the Invention

An embodiment of the invention will be described below.

### (1) Rubber Composition

A rubber composition in the present embodiment contains an EPDM rubber and porous carbon particles produced from a plant material (hereinafter, also simply referred to as “porous carbon particles”).

EPDM rubber is a polymer (terpolymer) obtained by copolymerizing ethylene, propylene, and diene as a third component. Examples of the third component include ethylidene norbornene, dicyclopentadiene, hexadiene and octadiene, etc. An EPDM containing ethylidene norbornene as the third component is preferable due to a high cross-linking rate and a good balance in physical properties.

The EPDM rubber has a structural unit derived from ethylene and a structural unit derived from diene. An EPDM rubber with a high ethylene content and a high diene content is preferably used since a large amount of porous carbon particles is mixed to the EPDM rubber as described later. If the EPDM rubber has excessively low ethylene and diene contents, adding a large amount of porous carbon particles thereto may cause a significant decrease in mechanical strength such as tensile strength and impairment of wear resistance. Therefore, the EPDM rubber with an ethylene content of not less than 55 mass % and not more than 65 mass % and a diene content of not less than 4.5 mass % and not more than 10.0 mass % is preferable.

Meanwhile, a hardness of the EPDM rubber is not specifically limited but is preferably not less than 40° and not more than 65°. When the hardness is less than 40° , the rubber composition when cross-linked may have a higher coefficient of friction and also lower wear resistance due to an increase in a specific wear rate. When the hardness is not less than 40°, the coefficient of friction can be controlled to be small and high wear resistance can be ensured by reducing the specific wear rate. On the other hand, when the hardness of the EPDM rubber is more than 65°, the hardness of the rubber composition excessively increases and appropriate rubber elasticity is not obtained after cross-linking, which may cause impairment of impact resistance. That is, use of the EPDM rubber having a hardness of not less than 40° and not more than 65° provides impact resistance to the rubber composition and also allows a slide member with a low coefficient of friction and a low specific wear rate to be obtained.

Meanwhile, the EPDM rubber has a main chain composed of saturated hydrocarbons and thus does not contain double bonds. Therefore, the molecular main-chain scission is less likely to occur in the EPDM rubber even when left in water for a long time. In other words, the EPDM rubber has better water resistance than other rubbers.

The porous carbon particle is a ceramics particle produced from a plant material. Examples of the porous carbon particles include RB ceramics particles produced from rice bran and RH ceramics particles produced from rice husk, etc. Of those, the RB ceramics particle is preferable in view of the effect of reducing the coefficient of friction and compatibility with the EPDM rubber. The RB ceramics particle is a hard porous carbon material which is composed of a carbide of defatted rice bran obtained from rice bran (soft amorphous carbon) and a glassy carbon as a carbide of a thermoplastic resin such as phenolic resin (hard amorphous carbon), and has several types of pores. The RB ceramics particle has high hardness, low friction and good wear resistance, and thus allows a slide member to have a reduced coefficient of friction and improved wear resistance.

The porous carbon particle content is not less than 160 parts by mass and not more than 340 parts by mass with respect to 100 parts by mass of the EPDM rubber. When the porous carbon particle content is less than 160 parts by mass, it is not possible to sufficiently reduce the coefficient of friction and also not possible to improve wear resistance when the rubber composition is cross-linked. The porous carbon particle content of more than 340 parts by mass excessively increases the hardness of the rubber composition, preventing the slide member to have sufficient rubber elasticity. The average grain size of the porous carbon particles is preferably not less than 2 μm and not more than 53 μm. Such an average grain size allows the porous carbon particles to uniformly disperse in the EPDM rubber and the rubber composition after cross-linking to have a low coefficient of friction without losing rubber elasticity.

The rubber composition in the present embodiment is to be cross-linked, and thus preferably contains a vulcanizing agent (cross-linking agent) and a vulcanization aid (cross-linking aid).

Examples of the vulcanizing agent include sulfur, sulfur compounds, inorganic vulcanizing agents other than sulfur, polyamine, resin vulcanizing agents, oximes, nitroso compounds, triazine-based agents and peroxide-based agents, etc., which can be used alone or in combination of two or more.

Examples of the peroxide-based vulcanizing agent include diacyl peroxides such as dibenzoyl peroxide, dicumyl peroxides, di-t-butyl peroxides, monoperoxy compounds (, e.g., peroxyesters such as t-butyl peroxyacetate, t-butylperoxy isopropyl carbonate, and t-butylperoxy benzoate), diperoxy compounds (2,5-dimethyl-2,5-di(t-butylperoxy)hexyne-3, 2,5-dimethyl-2,5-di(t-butylperoxy) hexane, 1,4-bis(t-butylperoxy isopropyl)benzene, 1,3-bis(t-butylperoxy isopropyl)benzene, and 2,5-dimethyl-2,5-di(benzoylperoxy)hexane, etc.), which can be used alone or in combination of two or more.

The vulcanization aid is not specifically limited as long as it can be used together with the vulcanizing agents listed above. It is possible to use, e.g., metal oxides, metal carbonates, amines, guanidine-based, aldehyde amine-based, aldehyde ammonia-based, thiazole-based, sulfonamide-based, thiourea-based, thiuram-based, dithiocarbamate-based and xanthate-based agents, allylic compounds, maleimides, methacrylates and divinyl compounds, etc., which can be used alone or in combination of two or more.

The total amount of the vulcanizing agent and the vulcanization aid is preferably not less than 5 parts by mass and not more than 25 parts by mass with respect to 100 parts by mass of the EPDM rubber. With such a total amount, hardness of a cross-linked rubber body (slide member) obtained by cross-linking the rubber composition can be controlled within an appropriate range and it is easy to reduce the coefficient of friction and to improve wear resistance.

In addition to the vulcanizing agent and the vulcanization aid, the rubber composition may also contain other additives, e.g., a processing aid such as wax or mineral oil, a reinforcing agent such as carbon black, a filler, a plasticizer, an anti-aging agent (antioxidant), and a stabilizer, etc. These additives can be added within a range not impairing characteristics of the rubber composition.

The filler may be either of inorganic type or organic type, and an inorganic filler or an organic filler can be used alone or a combination thereof

As the inorganic filler, it is possible to use carbon-based, silicate-based, magnesium carbonate-based, calcium carbonate-based, magnesium silicate-based, aluminum silicate-based, aluminum oxide-based, aluminum hydroxide-based, magnesium hydroxide-based, barium sulfate-based, silicon carbide-based and glass-based fillers, metal powder and high-strength fiber, etc.

As the organic filler, it is possible to use polyethylene (PE), polypropylene (PP), polystyrene (PS), acrylonitrile butadiene styrene resin (ABS resin), polycarbonate (PC), polyacetal (POM), polyoxymethylene, polyester, polyamide (PA), polyamide-imide (PM), polyphenylene ether (PPE), polyphenylene sulfide (PPS), polyether ketone (PEK), polyether ether ketone (PEEK), polyarylate, polyimide (PI), engineering plastic resins (liquid crystal polymer, etc.), chlorine resins (polyvinyl chloride, chlorinated polyethylene, etc.), fluorine resins (polyvinylidene fluoride (PVDF), ethylene tetrafluoroethylene (ETFE), polytetrafluoroethylene (PTFE), etc.), silicone resins, high-strength fiber and cellulose fiber, etc.

The rubber composition is obtained by mixing and kneading the EPDM rubber, the porous carbon particles, the vulcanizing agent, the vulcanization aid and, if necessary, the other additives.

### (2) Slide Member

The rubber composition described above is molded into a predetermined shape by injection molding or extrusion molding and is then cross-linked, thereby obtaining a cross-linked rubber body to be used as a slide member.

The slide member is configured to contain the EPDM rubber and a large amount of the porous carbon particles, and has rubber elasticity. Therefore, as compared to a slide member formed of a resin material or a carbon material, the slide member in the present embodiment is less likely to be broken by impact and is thus excellent in impact resistance.

In addition, since the porous carbon particles are exposed on the surface, the slide member is excellent in sliding properties with a low coefficient of friction as well as excellent in wear resistance with a low wear rate. More specifically, as is described in detail later, in the air (no lubrication in the air), the slide member has a low coefficient of friction of not more than 0.75 and a specific wear rate of not more than 2×10⁻⁵ mm²/N which indicates excellent wear resistance. Therefore, even in a case that the slide member is formed as a moving part (e.g., a bearing or a shaft seal, etc.) which mates with a member formed of metal or resin, etc., and is subjected to a predetermined pressure, frictional wear is suppressed and wear resistance thus can be maintained for a long time.

Furthermore, the coefficient of friction and the specific wear rate of the slide member are low in water. More specifically, as is described in detail later, in water, the coefficient of friction is as small as not more than 0.15 and the specific wear rate is not more than 2×10⁻⁵ mm²/N which indicates excellent wear resistance. The coefficient of friction can be lower especially when sliding in water against another member at a low speed and with a small load. In addition, since the slide member is formed using the EPDM rubber which is less likely to break down in water, the slide member is also excellent in water resistance. Therefore, excellent sliding properties and wear resistance can be maintained in water for a long time. It is presumed that the reason why the coefficient of friction in water can be reduced is as follows: due to water absorption by the porous carbon particles exposed on the surface of the slide member, water is taken in a sliding area where the slide member slides against the other member, allowing an excessive friction on the sliding surface to be reduced. Also, the slide member formed using the EPDM rubber excellent in water resistance does not denature or deteriorate even when the porous carbon particles absorb water, and the porous carbon particles can be conserved.

The slide member in the present embodiment is excellent in sliding properties and wear resistance, and thus can be used as a moving part subjected to a predetermined pressure, e.g., a gear, a lever, a bearing, a shaft seal (mechanical seal), etc. Furthermore, the slide member is excellent not only in sliding properties in water but also in water resistance, and thus can be suitably used as a component of devices used in water environment, e.g., an underwater gear, or a mechanical seal for sealing a main shaft of water turbine generator from water, etc. When the slide member in the present embodiment is used as, e.g., a mechanical seal of a water turbine generator, it is possible to reduce maintenance frequency and to improve power generation efficiency since the slide member can maintain wear resistance for a long time.

### EXAMPLES

Next, the invention will be described in more detail based on Examples. In this regard, however, the following examples are not intended to limit the invention.

### (1) Preparation of Rubber Composition

### Example 1

The rubber composition in Example 1 was prepared using the components and proportions shown in Table 1.

In detail, 100 parts by mass of an EPDM rubber, 249.63 parts by mass of heat-dried porous carbon particles, 40 parts by mass of carbon black, 11.42 parts by mass in total of a vulcanizing agent and a vulcanization aid and 15 parts by mass of a processing aid were mixed and the mixture was kneaded by an 8-inch rolling mill, thereby preparing the rubber composition.

The EPDM rubber used here was “Mitsui EPT3045” (ethylene content: 56 mass %, diene content: 4.7 mass %) manufactured by Mitsui Chemicals, Inc.

The porous carbon particle (RB ceramics) used was “RB ceramics powder” (grain size: not more than 10 μm) manufactured by Sanwa Yushi Co., Ltd.

The carbon black used was “SEAST 3” (grain size: 25 nm) manufactured by Tokai Carbon Co., Ltd.

The vulcanizing agent used was sulfur (“Rhenogran S-80” manufactured by Rhein Chemie Japan Ltd.).

The vulcanization aids used were tetramethylthiuram disulfide (“Rhenogran TMTD-80” manufactured by Rhein Chemie Japan Ltd.), tetraethylthiuram disulfide (“Rhenogran TETD-75F” manufactured by Rhein Chemie Japan Ltd.), stearic acid (“Beads Stearic Acid” manufactured by NOF Corporation), and zinc oxide (“META-Z L40” manufactured by Inoue Calcium Corporation).

The processing aid used was naphthenic oil (“Diana Process Oil NP-24” manufactured by Idemitsu Kosan Co., Ltd.).

TABLE 1

| | | | | Comparative | Comparative | Comparative |
|---|---|---|---|---|---|---|
| | Example 1 | Example 2 | Example 3 | Example 1 | Example 2 | Example 3 |
| Rubber (EPDM) | 100 | 100 | 100 | 100 | 100 | 100 |
| RB ceramics | 249.63 | 166.42 | 332.84 | — | 110.95 | 388.32 |
| Carbon black | 40 | 40 | 10 | 40 | 40 | 10 |
| Filler | — | — | 35 | — | — | 35 |
| Vulcanizing agent and | 11.42 | 11.42 | 10.5 | 11.42 | 11.42 | 10.5 |
| vulcanization aid | | | | | | |
| Processing aid | 15 | 15 | 10 | 15 | 15 | 10 |

### Example 2

The rubber composition in Example 2 was prepared in the same manner as Example 1, except that the RB ceramics content was 166.42 mass %.

### Example 3

In Example 3, 100 parts by mass of an EPDM rubber, 332.84 parts by mass of heat-dried porous carbon particles, 10 parts by mass of carbon black, 35 parts by mass of a filler, 10.5 parts by mass in total of a vulcanizing agent and a vulcanization aid and 10 parts by mass of a processing aid were mixed and the mixture was kneaded by an 8-inch rolling mill, thereby preparing the rubber composition.

The EPDM rubber used here was “JSR EP21” (ethylene content: 61 mass %, diene content: 5.8 mass %) manufactured by JSR Corporation.

The porous carbon particle (RB ceramics) used was “RB ceramics powder” (grain size: not more than 10 μm) manufactured by Sanwa Yushi Co., Ltd.

The carbon black used was “SEAST 3” (grain size: 25 nm) manufactured by Tokai Carbon Co., Ltd.

The filler used was “MSK-C” (grain size: 0.05 μm) manufactured by Maruo Calcium Co., LTD.

The vulcanizing agent used was sulfur (“Powder sulfur 200 mesh” manufactured by Hosoi Chemical Industry Co., Ltd.).

The vulcanization aids used were tetramethylthiuram disulfide (“Nocceler TT” manufactured by Ouchi Shinko Chemical Industrial Co., Ltd.), tetraethylthiuram disulfide (“Nocceler TET-G” manufactured by Ouchi Shinko Chemical Industrial Co., Ltd.), stearic acid (“Beads Stearic Acid” manufactured by NOF Corporation), and zinc oxide (“META-Z L40” manufactured by Inoue Calcium Corporation).

The processing aid used was epoxidized soybean oil (“Epocizer W-100-EL” manufactured by DIC Corporation).

### Comparative Example 1

The rubber composition in Comparative Example 1 was prepared in the same manner as Example 1, except that the RB ceramics was not added.

### Comparative Example 2

The rubber composition in Comparative Example 2 was prepared in the same manner as Example 1, except that the RB ceramics content was 110.95 parts by mass, i.e., less than 160 parts by mass.

### Comparative Example 3

The rubber composition in Comparative Example 3 was prepared in the same manner as Example 3, except that the RB ceramics content was 388.32 parts by mass, i.e., more than 340 parts by mass.

### (2) Manufacture of Samples

Subsequently, samples simulating slide members were made using the rubber compounds described above.

In detail, the rubber compositions in Examples 1 to 3 and Comparative Examples 1 to 3 were respectively extruded into a 5-mm thick sheet shape and the sheets were then pressed and vulcanized at 151° C. in a mold, thereby obtaining disc-shaped samples.

### (3) Evaluation Method

In order to evaluate friction properties and wear resistance of the obtained samples, a friction test described below was conducted on the samples and the coefficient of friction and the specific wear rate were measured.

### Friction Test in the Air Without Lubrication

Using a rotational friction tester as a testing machine, the friction test was conducted under the following sliding condition 1.

### Sliding Condition 1

Testing machine: rotational friction tester (rotary sliding)
Load: 1.96N
Sliding speed: 1.0 m/s
Number of cycles: 1.0×10⁴ cycles

In detail, firstly, the disc-shaped sample was placed on a stage of the friction tester. A 4-mm radius metal ball formed of high carbon-chromium bearing steel (ball test piece) was attached to the friction tester. The ball test piece was attached in contact with the sample so that a predetermined load (W) was applied to the sample. Then, the ball test piece was rotationally slid against the sample at a predetermined speed (sliding speed) for predetermined cycles.

The frictional force at this time was measured and the coefficient of friction in the air was then calculated. Then, the wear volume (V) in the friction test in the air was divided by the load (W) and the sliding distance (L), thereby calculating the specific wear rate in the air (V/W·L).

In this example, when the coefficient of friction in the air without lubrication was not more than 0.75 at the sliding speed of 1.0 m/s, it was evaluated as low friction (excellent in sliding properties). Meanwhile, when the specific wear rate in the air without lubrication was not more than 2×10⁻⁵ (mm²/N), it was evaluated as excellent in wear resistance.

Friction Test with Water Lubrication

The friction test with water lubrication was conducted in the same manner as the above-mentioned friction test in the air without lubrication, except that the ball test piece was slid against the sample in water under different sliding conditions. In this example, the friction test was conducted under the following sliding conditions 2 and 3 using a linear reciprocating friction tester or a rotational friction tester as a testing machine.

### Sliding Condition 2

Testing machine: linear reciprocating friction tester (reciprocating sliding)
Load: 0.98N
Sliding speed: 0.001 m/s
Number of cycles: 1.0×10³ cycles
Sliding Condition 3
Testing machine: rotational friction tester (rotary sliding)
Load: 4.9N
Sliding speed: 1.0 m/s
Number of cycles: 1.0×10⁴ cycles

From the results of the friction test, the coefficient of friction and the specific wear rate with water lubrication were calculated. In this example, when the coefficient of friction with water lubrication was not more than 0.15 at any sliding speeds (0.001 m/s, 1.0 m/s), it was evaluated as low friction (excellent in sliding properties). Meanwhile, when the specific wear rate with water lubrication was not more than 2×10⁻⁵ (mm²/N), it was evaluated in excellent in wear resistance.

### (4) Evaluation Result

The following is the result of the measurement of the coefficient of friction in the air. In Example 1, the coefficient of friction in the air was 0.3 due to the high content of the RB ceramics particles and was adjusted in a range of not more than 0.6. In Example 2, the coefficient of friction in the air was 0.74 due to the lower content of the RB ceramics particles than Example 1 and was greater than that in Example 1. In Example 3, the coefficient of friction in the air was 0.3 which is as low as that in Example 1.

In Comparative Example 1, the coefficient of friction in the air was 1.14, i.e., more than 0.75, since the RB ceramics particles were not contained. In Comparative Example 2, the RB ceramics particles were contained but the amount thereof was too small, resulting in that the coefficient of friction in the air was not sufficiently reduced and was 0.77. On the other hand, in Comparative Example 3, the sample was broken during the friction test presumably due to a significant decrease in rubber elasticity of the sample caused by excessively increasing the amount of the RB ceramics particles, and it was not possible to measure the coefficient of friction.

The following is the result of the measurement of the specific wear rate in the air. 1.73×10⁻⁷ (mm²/N) in Example 1 is in the range of not more than 2×10⁻⁵ (mm²/N), hence, excellent in wear resistance. Similarly, 1.23×10⁻⁵ (mm²/N) in Example 2 and 3.02×10⁻⁷ (mm²/N) in Example 3 are both in the range of not more than 2×10⁻⁵ (mm²/N), hence, excellent in wear resistance.

In Comparative Example 1, the specific wear rate in the air was 5.28×10⁻⁷ (mm²/N) and the sample had predetermined wear resistance in the same manner as Example 1, but this specific wear rate is greater than the sample in Example 1 containing the RB ceramics particles and wear resistance is thus poorer. In Comparative Example 2, specific wear rate was 2.77×10⁻⁵ (mm²/N), i.e., more than 2×10⁻⁵ (mm²/N), due to the low RB ceramics particle content, hence, poor wear resistance. In Comparative Example 3, since the sample was broken as described above, it was not possible to measure the specific wear rate.

The following is the result of the measurement of the coefficient of friction in water. In Example 1, the coefficient of friction was 0.05 at a sliding speed of 1 m/s and 0.11 at a sliding speed of 0.001 m/s. That is, in Example 1, the coefficient of friction at a low sliding speed was as low as at a high sliding speed. The coefficient of friction does not depend on the level of the sliding speed and was not more than 0.15 at any sliding speeds in the test range. In Example 2, the coefficient of friction was low in the same manner as Example 1 and was 0.13 at a low sliding speed. In Example 3, the coefficient of friction was not more than 0.15 at any sliding speeds in the test range in the same manner as Examples 2 and 3.

In Comparative Example 1, the coefficient of friction was 1.41 at a sliding speed of 0.001 m/s and 0.05 at a sliding speed of 1 m/s. That is, the slower the sliding speed, the higher the coefficient of friction in water tends to be. Comparative Example 2 exhibited the same tendency as Comparative Example 1. In Comparative Example 3, it was not possible to measure since the sample was broken.

Meanwhile, the result of the measurement of the specific wear rate in water was not more than 2×10⁻⁵ (mm²/N) in all of Examples 1 to 3 and Comparative Examples 1 to 3, hence, excellent in wear resistance.

As described above, in the air without lubrication, the slide members in Examples have a low coefficient of friction of not more than 0.75 and a low specific wear rate of not more than 2×10⁻⁵ mm²/N. Furthermore, when sliding the slide members in Examples against another member in water, the coefficient of friction at a low speed (0.001 m/s) is not more than 0.15 which is as low as at a high speed (1.0 m/s), and the specific wear rate in water is as low as not more than 2×10⁻⁵ mm²/N. Therefore, by using the rubber compositions in Examples, it is possible to form a slide member which is excellent in sliding properties and wear resistance in the air as well as in water.

### Preferred Embodiments of the Invention

The preferred embodiments of the invention will be described blow.
[1] An embodiment of the invention provides a rubber composition comprising:
an ethylene-propylene-diene rubber; and
porous carbon particles produced from a plant material,
wherein the porous carbon particle is comprised not less than 160 parts by mass and not more than 340 parts by mass relative to 100 parts by mass of the ethylene-propylene-diene rubber.
[2] Another embodiment of the invention provides a slide member comprising a cross-linked rubber body in which the rubber composition in [1] is cross-linked.
[3] The slide member in [2] may have a coefficient of friction of not more than 0.15 where a friction test is conducted in water at a load not less than 0.98N and not more than 4.9N applied by a 4-mm radius metal ball comprising a bearing steel and at a sliding speed of not less than 0.001 m/s and not more than 1.0 m/s.
[4] The slide member in [2] or [3] may have a coefficient of friction of not more than 0.75 where a friction test is conducted in the air at a load of 1.96N applied by a 4-mm radius metal ball comprising a bearing steel and at a sliding speed of 1.0 m/s.
[5] The slide member in [3] or [4] may have a specific wear rate in the friction test of not more than 2×10⁻⁵ mm2/N.

What is claimed is:

1. A rubber composition, comprising:
an ethylene-propylene-diene rubber; and
a porous carbon particle derived from a plant material, wherein not less than 160 parts by mass and not more than 340 parts by mass of the porous carbon particle is comprised relative to 100 parts by mass of the ethylene-propylene-diene rubber.

2. A slide member, comprising a cross-linked rubber body in which the rubber composition according to claim 1 is cross-linked.

3. The slide member according to claim 2, wherein a coefficient of friction thereof is not more than 0.15 where a friction test is conducted in water at a load of not less than 0.98N and not more than 4.9N applied by a 4-mm radius metal ball comprising a bearing steel and at a sliding speed of not less than 0.001 m/s and not more than 1.0 m/s.

4. The slide member according to claim 2, wherein a coefficient of friction thereof is not more than 0.75 where a friction test is conducted in the air at a load of 1.96N applied by a 4-mm radius metal ball comprising a bearing steel and at a sliding speed of 1.0 m/s.

5. The slide member according to claim 3, wherein a coefficient of friction thereof is not more than 0.75 where a friction test is conducted in the air at a load of 1.96N applied by a 4-mm radius metal ball comprising a bearing steel and at a sliding speed of 1.0 m/s.

6. The slide member according to claim 3, wherein a specific wear rate in the friction test is not more than 2×10⁻⁵ mm²/N.

7. The slide member according to claim 4, wherein a specific wear rate in the friction test is not more than 2×10⁻⁵ mm²/N.

8. The slide member according to claim 5, wherein a specific wear rate in the friction test is not more than 2×10⁻⁵ mm2/N.
